(19) United States
(12) Patent Application Publication
(10) Pub. No.: US 2015/0242351 A1
(43) Pub. Date: Aug. 27, 2015

(54) STORAGE SYSTEM, CONTROL APPARATUS, AND COMPUTER-READABLE RECORDING MEDIUM HAVING STORED THEREIN CONTROL PROGRAM

(71) Applicant: FUJITSU LIMITED, Kawasaki-shi (JP)

(72) Inventor: Takuma SUZUKI, Kawasaki (JP)

(21) Appl. No.: 14/624,610

(22) Filed: Feb. 18, 2015

(30) Foreign Application Priority Data
Feb. 21, 2014 (JP) 2014-031783

(51) Int. Cl. G06F 13/40

(52) U.S. Cl. CPC G06F 13/4022

(57) ABSTRACT

By including an abnormality detection unit that detects an occurrence of an abnormality in any one of a plurality of paths; a specifying unit that specifies an abnormal place based on the number of communication abnormalities and the number of IOs when the occurrence of the abnormality is detected in the path; and a switching control unit that causes any one of a plurality of higher-level apparatuses and a relay apparatus to execute path switching for switching a data communication path from the path in which the occurrence of the abnormality is detected to another path among the plurality of paths in accordance with the specified abnormal place, effective path switching according to the place at Which the path abnormality occurs is performed.

### CROSS-REFERENCE TO RELATED APPLICATION

This application is based upon and claims the benefit of priority of the prior Japanese Patent application No. 2014-031783, filed on Feb. 21, 2014, the entire contents of which are incorporated herein by reference.

### FIELD

The embodiments discussed herein are directed to a storage system, a control apparatus, and a control program.

### BACKGROUND

FIG. 11 is a diagram that illustrates the configuration of a storage system in a storage area network (SAN) environment.

In the storage system 400 illustrated in FIG. 11, two hosts 200a and 200b are connected to a storage apparatus 500 respectively through switches 300a and 300b.

More specifically, the switch 300a is connected to a Port #0 of the storage apparatus 500, and the switch 300b is connected to Port #1 of the storage apparatus 500. In addition, hosts 200a and 200b are respectively connected to the switches 300a and 300b.

In other words, between the host 200a and the storage apparatus 500, two paths including a path (Path #0) connecting to the storage apparatus 500 through the switch 300a and Port #0 and a path (Path #1) connecting to the storage apparatus 500 through the switch 300b and Port #1 are formed.

Here, the host 200a may be referred to as Host #0, and the host 200b may be referred to as Host #1. Similarly, the switch 300a may be referred to as Switch #0 and the switch 300b may be referred to as Switch #1.

As illustrated in PIG. 11, generally, in a storage system in the SAN environment, a host and a storage apparatus are connected through a plurality of paths (Multipath) to have a redundant configuration.

In the storage system 400 illustrated in FIG. 11, when Host #0 is considered, a redundant configuration including a path (Path #0) passing through Switch #0 and a path (Path #1) passing through Switch #1 is employed.

Here, for Host #0, it is assumed that Path #0 is an active path, and Path #1 is a standby path. When an abnormality is detected in the active path, a multi-path driver (not illustrated in the figure) of Host #0 performs control of switching to the standby path. More specifically, when an abnormality occurs in Path #0, and command retry timeout of the active path is detected, the multi-path driver of Host #0 switches the path from the active path (Path #0) to the standby path (Path #1).

The switching of the path from the active path to the standby path is performed by causing a target port of the storage apparatus 500 to be in a link down state.

PATENT LITERATURE 1: Japanese Laid-open Patent. Publication No. 2006-107151

PATENT LITERATURE 2: Japanese Laid-open Patent Publication No. 2002-278909

PATENT LITERATURE 3: Japanese Laid-open Patent Publication No. 2005-251078

PATENT LITERATURE 4: Japanese Laid-open Patent Publication No. 2008-299434

However, in such a conventional storage apparatus, in order to switch the path between the host 200a and the storage apparatus 500, a corresponding port is caused to be in the link down state. Thus, the other host 200b that shares this port or a path using this port cannot use the path. In other words, there is a problem in that the other hosts are affected by causing the port to be in the link down state.

For example, in the configuration illustrated in FIG. 11, according to an abnormality of Path to that is detected, in communication between Host #0 and the storage apparatus 500, Port #0 of the storage apparatus 500 is caused to be in the link down state. Accordingly, the other host Host #1 using this port. Port #0 cannot use Path #0 as well.

### SUMMARY

According to an aspect of the embodiments, a control apparatus for controlling a storage apparatus that is connected to a plurality of higher-level apparatuses in a plurality of paths through a relay apparatus includes: an abnormality detection unit that detects an occurrence of an abnormality in any one of the plurality of paths; a specifying unit that specifies an abnormal place on a basis of the number of communication abnormalities and the number of IOs when the occurrence of the abnormality is detected in the path; and a switching control unit that performs control for causing any one of the plurality of higher-level apparatuses and the relay apparatus to execute path switching of a data communication path from the path in which the occurrence of the abnormality is detected to any other standby path among the plurality of paths in accordance with the specified abnormal place.

The object and advantages of the invention will he realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram that schematically illustrates the hardware configuration of a storage system as an example of an embodiment;

FIG. 2 is a diagram that illustrates the functional configuration for realizing a path switching control function of the storage system as an example of the embodiment;

FIG. 3 is a diagram that illustrates an exemplary management table in the storage system as an example of the embodiment;

FIG. 4 is a diagram that illustrates an abnormal place in the storage system as an example of the embodiment;

FIG. 5 is a diagram that illustrates a method of specifying an abnormal place in the storage system as an example of the embodiment;

FIG. is a flowchart that illustrates an overview of a path switching process performed by the storage system as an example of the embodiment;

FIG. 7 is a flowchart that illustrates the path switching process in detail that is performed by the storage system as an example of the embodiment;

FIG. 9 is a flowchart that illustrates a TPGS path closing process performed by the storage system as an example of the embodiment;

FIG. 9 is a sequence diagram that illustrates the TPGS path closing process performed by the storage system as an example of the embodiment in a case where no sense loss occurs;

FIG. 10 is a sequence diagram that illustrates the TPGS path closing process performed by the storage system as an example of the embodiment in a case where a sense loss occurs; and

FIG. 11 is a diagram that illustrates the configuration of a storage system in a SAN environment.

### DESCRIPTION OF EMBODIMENT(S)

Hereinafter, a storage system, a control apparatus, and a control program according to embodiments will be described with reference to the drawings. Note that the embodiments described below are described by way of example only, and various modifications and applications of techniques that are not provided explicitly in the following embodiment are not intended to be excluded. That is, the present embodiments can be practiced in various ways without departing from the spirit thereof. The drawings are not intended to include only components illustrated in the drawings, but may include other functions.

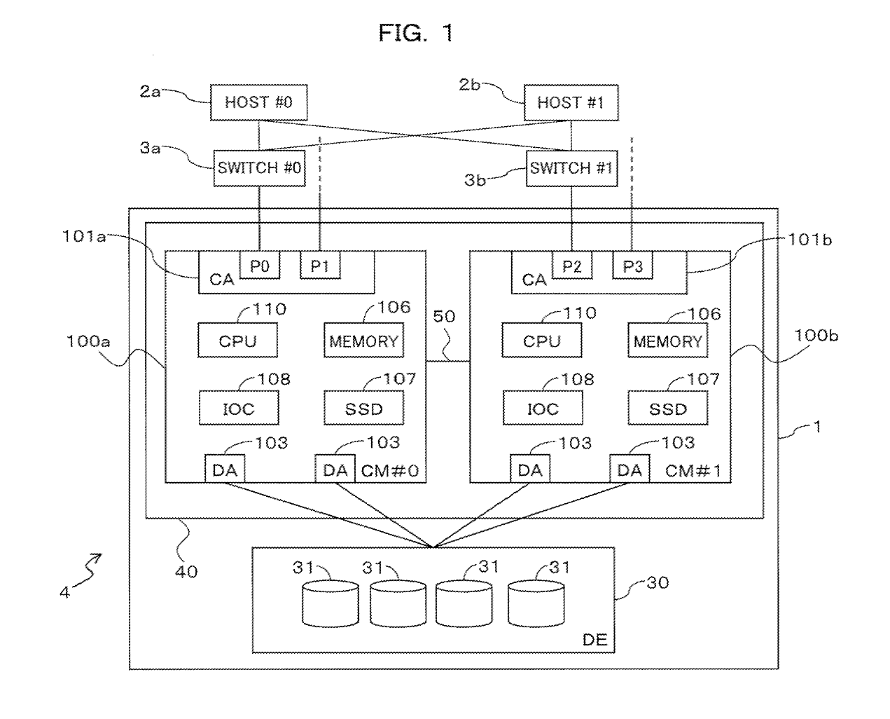

FIG. 1 is a diagram that schematically illustrates the hardware configuration of a storage system 4 as an example of an embodiment.

In the storage system 4, a storage apparatus 1 and a plurality of (two in the example illustrated in FIG. 1) host apparatuses 2a and 2b are connected through a plurality of redundant paths.

The storage apparatus 1 is an information processing apparatus that forms a virtual storage environment by virtualizing a storage device 31 stored in a drive enclosure (DE) 30. The storage apparatus 1 provides the host apparatuses 2a and 2b that are higher-level apparatuses with a virtual volume.

The storage apparatus 1 is connected to the host apparatuses 2a and 2b in a communicable manner. The host apparatuses 2a and 2b and the storage apparatus 1 are connected through communication adapters (CAs) 101a and 101b to be described later.

The host apparatuses 2a and 2b, for example, are Information processing apparatuses each having a server function and transmits/receives a command of a network attached storage (NAS) or the SAN to/from the storage apparatus 1. The host apparatuses 2a and 2b have the same configuration.

Hereinafter, as a reference sign representing a host apparatus, in a case where one host apparatus among the plurality of host apparatuses needs to be specified, reference signs “2a” and “2b” will be used, and, in a case where an arbitrary host apparatus is to be represented, reference sign “2” will be used. In addition, the host apparatus 2a may he represented as Host #0, and the host apparatus 2b may be represented as Host #1.

The host apparatus 2 includes a central processing unit (CPU) and a memory not illustrated in the figure and, by executing an operating system (OS) or a program stored in the memory or the like using the CPU, various functions are realized.

The host apparatus 2, for example, transmits a disk access command of the NAS such as a read command or a write command to the storage apparatus 1, thereby reading or writing data from/into a volume provided by the storage apparatus 1.

Then, in response to an input/output request for example, a read command or a write command) for reading or writing data that is performed by the host apparatus 2 for a volume, the storage apparatus I performs a process such as data reading or data writing for an actual storage corresponding to the volume. Hereinafter, the input/output request from the host apparatus 2 may be referred to as an IO command or simply to as an IO.

In addition, the host apparatus 2 includes a multi-path driver that connects the host apparatus 2 and the storage apparatus 1 through a plurality of paths (Multipath) so as to be redundant.

The multi-path driver has a function for detecting an occurrence of a link down (cut off) or link up (connection) in a path between the storage apparatus 1 and the host apparatus 2.

For example, when a state in which a communication port not illustrated in the figure cannot communicate with the storage apparatus 1 occurs in the host apparatus 2, the multi-path driver detects a link down. For example, in a case where the host apparatus 2 and the storage apparatus 1 are connected through a fibre channel (FC), when transmission light is detected to be turned off continuously for a predetermined time or more, a link down is detected.

The detection of a link down or link up in the path between the storage apparatus 1 and the host apparatus 2, which is performed in the host apparatus 2, can be realized, using an existing technique, and detailed description thereof will not be presented here.

The multi-path driver has a function for path switching when a link down for the storage apparatus 1 is detected. In other words, when a link down of an active path used for data communication is detected among a plurality of paths connecting the host apparatus 2 and the storage apparatus 1, the multi-path driver selects another path (standby path) set in advance and performs path switching so as to perform data communication using this standby path (first path switching function).

The multi-path driver relates to a known technology, and thus, detailed description thereof will not be presented here. In addition, the path switching in the host apparatus 2 which is performed by the multi-path driver can be realized using an existing technique, and thus, detailed description thereof will not be presented here.

As such multi-path drivers, there are a target port group support (TPGS)-compliant driver and a non-TPGS-compliant driver. The TPGS is a function for specifying an optimal path between the host apparatus 2 and the storage apparatus 1 and is a path switching control function. The TPGS relates to a known technology, and detailed description thereof will not he presented here.

When a path state change notification to path switching instruction or a TPGS path closing instruction) is received from the storage apparatus 1, the TPGS-compliant multi-path driver closes the active path in which an abnormality occurs, thereby performing path switching to the standby path (second path switching function). The TPGS path closing instruction or a path closing process according to the TPGS will be described later with reference to FIG. 8.

Whether a multi path driver is compliant with the TPGS can be determined based on whether or not a report target port groups (RTPG) command is received from the host apparatus 2 after a sense of a multiple path rebuilding is responded from the storage apparatus 1 to the host apparatus 2. In other words, in a case where a RTPG command is received from the host apparatus 2 after a sense of multiple path rebuilding is responded, the multi-path driver of this host apparatus 2 can be determined to be compliant with the TPGS.

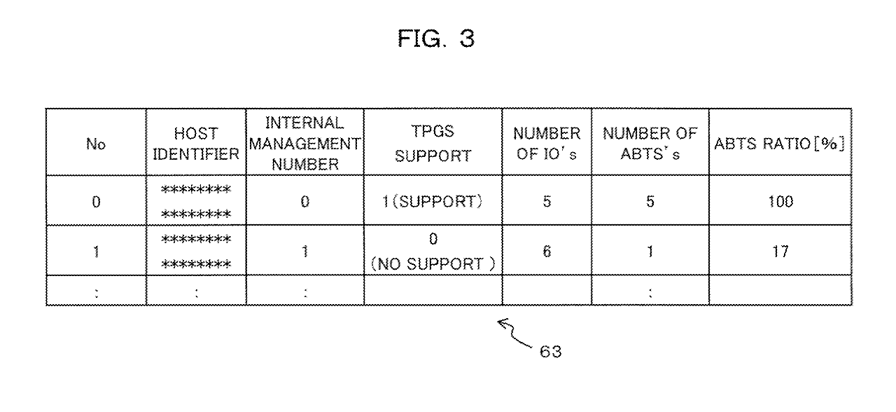

Information of reception/no-reception of an RTPG command from the host apparatus 2 is collected in advance in the storage apparatus 1, and it is determined whether or not the host apparatus 2 is compliant with the TPGS, and a result of the determination is managed by a management table 63 (see FIG. 3) to be described later.

In addition, the host apparatus 2 has a function of issuing an abort sequence (ABTS) for cancelling an issued IO command in a case where there is no response within a predetermined time after the issuance of the IO command to the storage apparatus 1. In other words, the ABTS serves as a communication abnormality notification signal that represents detection of an error after the issuance of an IO to the host apparatus 2.

Furthermore, the issuance of the ABTS can be realized using an existing technique, and detailed description thereof will not be presented here.

The switches 3a and 3b are relay apparatuses that relay communication between the host apparatuses 2a and 2b and the CMs 100a and 100b. The switches 3a and 3b are connected to the host apparatuses 2a and 2b, the switch 3a is connected to the CM 100a, and the switch 3b is connected to the CM 100b.

In other words, the host apparatuses 2a and 2b are connected to the CM 100a through the switch 3a and are also connected to the CM 100b through the switch 3b.

In the example illustrated in FIG. 1, two ports P0 and P1 are arranged in the CA 101a, and two ports P2 and P3 are arranged in the CA 101b. In addition, the switch 3a is connected to the port P0, the switch 3b is connected to the port P2, and the host apparatuses 2a and 2b are connected to the switches 3a and 3b.

In other words, each of the host apparatuses 2a and 2b is connected to the port P0 of the CA 101a through the switch 3a and is also connected to the port P2 of the CA 101b through the switch 3b.

The storage apparatus 1, as illustrated in FIG. 1, includes a plurality of (two in this embodiment) controller modules (CMs) 100a and 100b and one or more (one in the example illustrated in FIG. 1) drive enclosure 30.

The drive enclosure 30 can have one or more (four in the example illustrated in FIG, 1) storage devices (physical disks) 31 mounted thereon and provides storage areas (actual volumes or actual storages) of the storage devices 31 for the storage apparatus 1.

For example, the drive enclosure 30 includes multiple stages of slots (not illustrated in the figure) and, by inserting storage devices 31 such as a hard disk drive (HDD) and a solid state drive (SSD) into such slots, the actual capacity of the volume can be changed at any time. In addition, by using a plurality of the storage devices 31, redundant arrays of inexpensive disks (RAID) may be configured.

The drive enclosure 30 is connected to device adapters (DAs) 103 and 103 of the CM 100a and DAs 103 and 103 of the CM 100b. Any one of the CMs 100a and 100b can read or write data by accessing the drive enclosure 30. In ether words, by connecting the CMs 100a and 100b to the storage devices 31 of the drive enclosure 30, access paths for the storage devices 31 are configured to be redundant.

A controller enclosure 40 includes one or more (two in the example illustrated in FIG. 1) CMs 100a and 100b.

The CMs 100a and 100b are controllers (control apparatuses; storage control apparatuses) that control the operation performed inside the storage apparatus 1 and perform various control operations such as control of accesses from the drive enclosure 30 to the storage devices 31 according to an IO command transmitted form the host apparatus 2. The CMs 100a and 100b have configurations that are almost the same. Hereinafter, as a, reference sign representing the CM, when one of the plurality of CMs need to be specified, reference sign 100a or 100b will be used, and, when an arbitrary CM is to be represented, reference sign 100 will be used. The CM 100a may be represented as CM #0, and the CM 100b may be represented as CM #1.

In the drawings, the same reference numeral denotes a same portion or portions that are approximately the same, and thus, detailed description thereof will not be presented.

The CMs 100a and 100b are configured to be redundant, and, normally, the CM 100a performs various control operations as a primary communication module. However, when the primary CM 100a is broken down, the CM 100b that is a secondary Communication module successes the operation of the CM 100a as a primary communication module.

The CMs 100a and 100b are connected to the host apparatus 2 respectively through the CAs 101a and 101b. Each of the CMs 100a and 100b receives an IO command such as a read command or a write command transmitted from the host apparatus 2 and controls the storage device 31 through the DA 103 and the like. In addition the CMs 100a and 100b are communicably connected together through a communication line 50. This communication line 50 is connected using an interface such as a PCI Express (registered trademark).

Each of the CMs 100a and 100b, as illustrated in FIG. 1, includes a CA 101a or 101b and a plurality of two in the example illustrate in FIG. 1) DAs 103 and 103 and also includes a central processing unit (CPU) 110, a memory 106, an SSD 107, and an IOC 108.

In the example illustrated in FIG. 1, the CA 101a is arranged in the CM 100a, and the CA 101b is arranged in the CM 100b. Here, as a reference sign that represents the CA, when one of the plurality of CAs needs to be specified, reference sign 101a or 101b will be used, and, when an arbitrary CA is to be represented, reference sign 101 will be used.

The CA 101 receives data transmitted from the host apparatus 2 or the like and transmits data output from the CM 100 to the host apparatus 2 or the like. In other words, the CA 101 controls input/output (IO) of data for an external apparatus such as the host apparatus.

The CA 101 is a network adapter connecting the host. apparatus 2 through the NAS in a communicable manner and, for example, is a local area network (LAN) interface, an internet small computer system interface (iSCSI), a fibre channel (FC) interface, or the like. The CM 100 is connected to the host apparatus 2 and the like through a communication line by the CA 101 through the NAS and performs reception of an IO command, transmission/reception of data, and the like.

In addition, the CA 101 includes one or more ports, and a communication line used for communicating with the host apparatus 2 is connected to each of the ports.

In the example illustrated in FIG. 1, two ports P0 and P1 are arranged in the CA 101a, and two ports P2 and P3 are arranged in the CA 101b. The switch 3a is connected to the port P0, and the switch 3b is connected to the port P2, and the host apparatuses 2a and 2b are respectively connected to the switches 3a and 3b.

In other words, the host apparatuses 2a and 2b are connected to the port P0 of the CA 101a through the switch 3a and are connected to the port P2 of the CA 101b through the switch 3b.

The DA 103 is an interface used for communicably connecting the drive enclosure 30, the storage device 31, and the like. The DA 103 is connected to the storage device 31 of the drive enclosure 30, and the CM 100 controls accesses to the storage device 31 based on an IO command received from the host apparatus 2.

The CM 100 performs data reading or data reading for the storage device 31 through the DA 103. In the example illustrated in FIG. 1, two DAs 103 and 103 of the CMs 100a and 100b are arranged. In addition, The drive enclosure 30 is connected to each of the DAs 103 of the CMS 100a and 100b.

Accordingly, any of the CMs 100a and 100b can perform data reading or data writing for the storage device 31 of the drive enclosure 30.

The SSD 107 is a storage device that stores programs executed by the CPU 110, various kinds of data, and the like.

The memory 106 is a storage device that temporarily stores various kinds of data and programs and includes a memory region and a cache region. that are not illustrated in the figure. The cache region temporarily stores data received from the host apparatus 2 or data to be transmitted to the host apparatus 2, When the CPU 110 executes a program, the CPU 110 uses the memory region by temporarily storing and expanding data or a program therein.

In addition, in the memory 106, information of an IO counter value 61, an ABTS counter value 62, and the management table 63, a first threshold 64, a second threshold 65, and third threshold 66, which will be described later, are stored in the storage region. In addition, by denoting the value of the first threshold 64, the value of the second threshold 65, and the value of the third threshold 66 as L, M, and N, hereinafter, the thresholds may be respectively represented as a threshold L, a threshold M, and a threshold N.

The input output controller (IOC) 108 is a control device that controls data transmission performed inside the CM 100 and, for example, realizes direct memory access (DMA) transmission for transmitting data stored in the memory 106 not through the CPU 110.

The CPU 110 is a processing unit that performs various control operations and arithmetic operations and is a multi-core processor (multiple CPUs). By executing an OS or a program stored in the SSD 107 or the like, the CPU 110 realizes various functions.

For example, by executing a control program (path switching control program), the CPU 110 realizes a path switching control function for controlling switching the path from an abnormal path to a standby path.

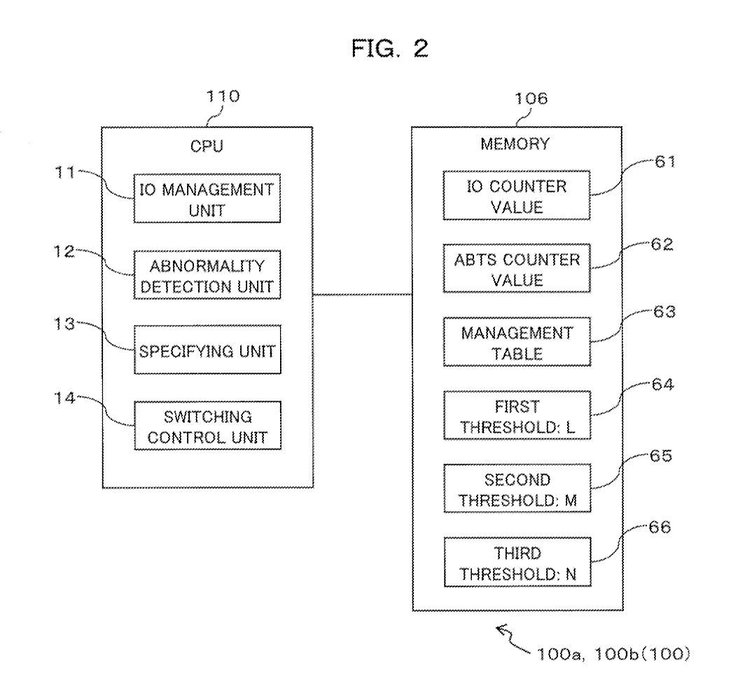

In other words, by executing a control program, the CPU 110 serves as an IO management unit 11, an abnormality detection unit 12, a specifying unit 13, and a switching control unit 14 as illustrated in FIG. 2.

FIG. 2 is a diagram that illustrates the functional configuration for realizing the path switching control function of the storage system 4 as an example of the embodiment.

As illustrated in FIG. 2, the storage apparatus 1 serves as the IO management unit 11, the abnormality detection unit 12, the specifying unit 13, and the switching control unit 14.

In addition, a program (path switching control program) used for realizing the functions of the IO management unit 11, the abnormality detection unit 12, the specifying unit 13, and the switching control unit 14, for example, is provided in a form being recorded on a computer-readable recording medium such as a flexible disk, a CD (a CD-ROM, a CD-R, a OD-RW, or the like), a DVD (a DVD-ROM, a DVD-RAM, a DVD-R a DVD+R, a DVD-RW, a DVD+RW, an HD DVD, or the like), a Blu-ray disk, a magnetic disk, an optical disc, or a magneto-optical disk. Then, a computer reads the program from the recording medium and transmits the program to an internal storage device or an external storage device so as to be stored therein for the use. Alternatively, the program may be configured to be recorded in a storage device (recording medium) such as a magnetic disk, an optical disc, or a magneto-optical disk and provided from the storage device for the computer through a communication path.

In order to realize the functions of the IO management unit 11, the abnormality detection unit 12, the specifying unit 13, and the switching control unit 14, the program stored in the internal storage device the memory 106 or the SSD 107 in this embodiment) is executed by a microprocessor (the CPU 110 in this embodiment) of the computer. At this time, the program that is stored on a recording medium may be read and executed by the computer.

The IO management unit 11 monitors communication with the host apparatus 2 and manages the communication using the IO counter value 61, the ABTS counter value 62, and the management table 63.

The IO management unit 11 monitors a state of communication with the host apparatus 2 and manages a communication result (communication state) for each of the ports P0 to P3 arranged in the storage apparatus 1.

More specifically, the IO management unit 11 counts the number (IO command number) of IO commands received from the host apparatus 2 for each port of the CA 101 by using the IO counter value 61. in addition, the IO management unit 11 counts the number (ABTS number) of received ABTSs that are issued from the host apparatus 2 by using the ABTS counter value 62.

The IO counter value 61 is arranged for each host apparatus 2, and the IO management unit 11 counts up each IO counter value 61 by being triggered upon the reception of an IO command transmitted from each host apparatus 2.

The ABTS counter value 62 is arranged for each host apparatus 2, and the IO management unit 11 counts up each ABTS counter value 62 by being triggered upon the reception of an ABTS transmitted from each host apparatus 2.

In FIG. 2, for the convenience of description, one IO counter value 61 and one ABTS counter value 62 are illustrated.

The IO counter value 61, the ABTS counter value 62, and the management table 63, for example, are stored in the memory 106.

FIG. 3 is a diagram that illustrates the management table 63 of the storage system 4 as an example of the embodiment.

The IO management unit 11, for each port, manages information representing TPGS compliance/non-TPGS compliance, an IO number, an ABTS number, and an ABTS ratio for each host apparatus 2, which is a communication destination, in the management table 63. In the management table 63 illustrated in FIG. 3, such information is associated with a host identifier and an internal management number so as to be associated with the host apparatus 2.

Here, the host identifier is identification information used for specifying the host apparatus 2, and, for example, a world wide name (WWN) or an SCSI name of the host apparatus 2 is used as the host identifier.

The internal management number is a number that is set for managing the host apparatus 2. As the information representing TPGS compliance/non-TPGS compliance, for example, “1” is set in a case where the host apparatus 2 is in compliance with the TPGS, and “0” is set in it case where the host apparatus 2 is not in compliance with the TPGS.

The IO number is the number of IOs received from the host apparatus 2, and the above-described IO counter value 61 is stored as the IO number. In addition, the ABTS number is the number of ABTSs received from the host apparatus 2, and the above-described ABTS counter value 62 is stored as the ABTS number.

The ABTS ratio is a ratio of the ABTS number to the number of IOs (IO number) received from the host apparatus 2 and is calculated using the IO number and the ABTS number described above by the IO management unit 11. In the example illustrated in FIG. 3, as the ABTS ratio, a % value is set,

In the storage apparatus 1, the management table 63 is arranged for each port of the CA 101, and, for each CM 100, the management table 63 for each port included in the CA 101 is generated. In other words, for the CM 100a, the IO management unit 11 generates the management tables 63 for the ports P0 and P1, and, for the CM 100b, the IO management unit 11 generates the management table 63 for the ports P2 and P3.

Then, each CM is notified of the management tables 63 generated for the CMs 100 through the communication line 50, and the management tables 63 are synchronized with one another. Accordingly, each CM 100 manages communication results of all the ports including the ports of the other CMS 100.

The abnormality detection unit 12 detects an occurrence of an abnormality (path abnormality) in the path between the storage apparatus 1 and the host apparatus 2.

The abnormality detection unit 12 determines the occurrence of a path abnormality by comparing the ABTS ratio with the valve M of the second threshold 65. In other words, the abnormality detection unit 12 reads the ABTS ratio of the host apparatus 2 that is the determination target by referring to the management table 63. Then, the abnormality detection unit 12 determines whether or not an abnormality (path abnormality) occurs in the path between the storage apparatus 1 and the host apparatus 2 by comparing this ABTS ratio and the threshold N with each other. In a case where the ABTS ratio is the threshold M or more, the abnormality detection unit 12 determines that an abnormality (path abnormality) occurs in the path between the storage apparatus 1 and the host apparatus 2.

In this way, the abnormality detection unit 12 detects an occurrence of a path abnormality based on the ratio (ABTS ratio) of the number of communication abnormalities to the number of IOs of the ABTS issuance source for the host apparatus 2.

In addition, in a case where the ABTS counter value 62 is determined to be the value L of the first threshold 64 or more, the abnormality detection unit 12 starts to determine whether or not the path abnormality described above is present.

When the abnormality detection unit 12 detects an occurrence of the path abnormality, the specifying unit 13 specifies an abnormal place based on the ABTS number and the IO number. More specifically, the specifying unit 13 calculates a ratio (an ABTS ratio of all the hosts) of a sum (total ABTS number) of the number of ABTSs (ABTS number) issued by each host apparatus 2 to a sum (total IO number) of the number of IOs (IO number) issued by each host apparatus 2 for all the host apparatuses 2 using the ports P0 to P3 arranged in the corresponding storage apparatus 1. The IO numbers and the ABTS numbers used for calculating the ABTS ratio of all the hosts, for example, are read from the management table 63 so as to be acquired.

Then, the specifying unit 13 determines an abnormal place based on the ABTS ratio of each host apparatus 2. More specifically, the specifying unit 13 compares the ABTS ratio of all the hosts with the third threshold N and, in a case where ABTS ratio of all the hosts is the threshold N or more, determines an abnormality occurrence place to be located between the switch 3 and the corresponding storage apparatus 1. On the other hand, in a case where the ABTS ratio of all the hosts is less than the threshold N, the specifying unit 13 determines an abnormality occurrence place to be located between the host apparatus 2 and the switch 3.

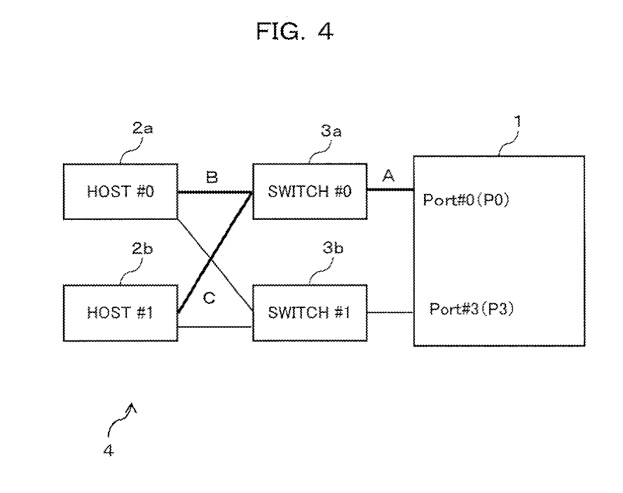

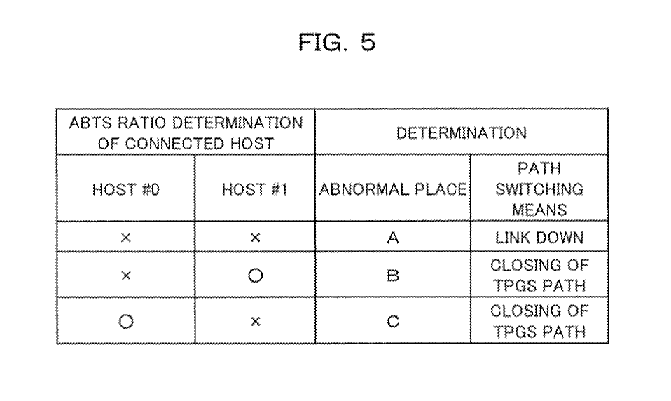

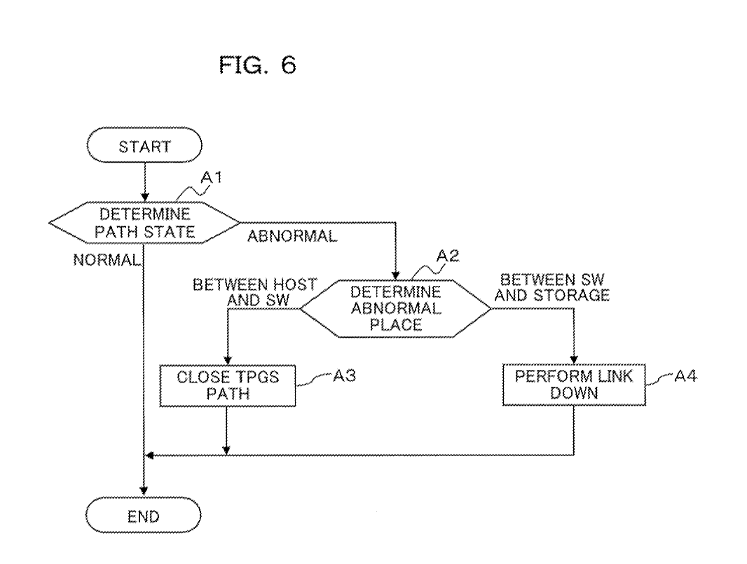

FIG. 4 is a diagram that illustrates an abnormal place in the storage system 4 as an example of the embodiment, and FIG. 5 is a diagram that illustrates a method of specifying the abnormal place. In the example illustrated in FIGS. 4 and 5, the port P0 of the storage apparatus 1 is illustrated.

In the storage system 4 illustrated in FIG. 4, a path between the storage apparatus 1 and the switch 3a is denoted by reference sign A, a path between the host apparatus 2a and the switch 3a is denoted by reference sign B, and a path between the host apparatus 2b and the switch 3a is denoted by reference sign C.

In FIG. 5, “DETERMINATION OF ABTS RATIO OF CONNECTED HOST” represents a result of comparison of the ABTS ratios of the host apparatuses 2 with he threshold N described above, “o” is set therein in a case where the ABTS ratio is less than the threshold N, and “x” is set therein in a case where the ABTS ratio is the threshold N or more. In addition, in FIG. 5, in correspondence with each combination of comparison results of the ABTS ratios of Host #0 and Host #1 with the threshold N, an abnormality place and a path switching means are set as “DETERMINATION”.

The abnormal place is a position at which an abnormality is assumed to occur in the storage system 4 and, for example, represents one of path positions denoted by reference signs A, B, and C in FIG. 4. The path switching means represents a means for controlling that switching of the path from the abnormal path to the standby path that is performed by the switching control unit 14 to be described later. This path switching means will be described later.

In the example illustrated in FIG. 5, in a case where any one of the ABTS ratios of the host apparatus 2a (Host #0) and the host apparatus 2b (Host #1) is the threshold N or more, the specifying unit 13 is represented to determine that the abnormal place is in the path A between the storage apparatus 1 and the switch 3a in FIG. 4.

On the other hand, in a case where the ABTS ratio of Host #0 is the threshold N or more, and the ABTS ratio of Host #1 is less than the threshold N, the specifying unit 13 determines that the abnormal place is in the path B between the host apparatus 2a and the switch 3a in FIG. 4 In addition, in a case where the ABTS ratio of Host #0 is less than the threshold N, and the ACTS ratio of Host #1 is the threshold N or more, the specifying unit 13 determines that the abnormal place is in the path C between the host apparatus 2b and the switch 3a in FIG. 4.

The switching control unit 14 performs control for causing the host apparatus 2 to perform path switching for switching the path from an active path in which an abnormality has occurred to a standby path and performs path switching control using a switching means according to the abnormal place that is specified by the specifying unit 13.

In a case where the abnormal place is located between the switch 3 and the corresponding storage apparatus 1, the switching control unit 14 causes a port (target port) of the storage apparatus 1 to which the abnormal path is connected to be in a stopped state (port stopped state), thereby forming a link down state. Accordingly, the multi-path driver detects a link down of the host apparatus 2 and performs path switching from the active path such that data communication with the storage apparatus 1 is performed using the standby path.

The switching control unit 14, for example, suppresses the supply of power to a target port so as to cause this port to be in an unusable state (port stopped state), thereby causing the abnormal path to be in a cut-off state (link down state). Here, a process of causing a port to be in the port stopped state will be referred to as a port stopping process. In addition, the port stopping process may be realized by using various existing techniques instead of the suppression of the supply of power to the target port.

In order to cause a link down of an abnormal path, various existing techniques may be used, and detailed description thereof will not be presented here.

On the other hand, in a case where the abnormal place is not located between the switch 3 and the storage apparatus 1, the switching control unit 14 suppresses the link down of the target port. In addition, in a case where the abnormal place is not located between the switch 3 and the storage apparatus 1, and the host apparatus 2 is compliant with the TPGS, the switching control unit 14 instructs the host apparatus 2 to close the TPGS path (path switching instruction).

It can be determined whether or not the host apparatus 2 is compliant with the TPGS by referring to the management table 63.

The host apparatus 2 that has received the TPGS path closing instruction from the storage apparatus 1 performs the process of closing the path according to the TPGS. In this way, the switching of the data communication path from the abnormal path to the standby path is performed.

In the example illustrated in FIG. 5, both host apparatuses 2a and 2b are assumed to be compliant with the TPGS. In a case where the ABTS ratios of both Host #0 and Host #1 are the threshold N or more, the switching control unit 14 is illustrated to perform switching the path to the standby path for the host apparatus 2 by causing the link down of the target port P0 in FIG. 5.

In addition, in a case where the ABTS ratio of one of Host #0 and Host #1 is less than the threshold N, and the ABTS ratio of the other thereof is the threshold N or more, the switching control unit 14 instructs the host apparatus 2 to perform TPGS path closing, thereby switching the communication path from the abnormal path to the standby path for the host apparatus 2.

An overview of the path switching process performed by the storage system 4 as an example of the embodiment configured as described above will be described with reference to a flowchart (steps A1 to A4) illustrated in FIG. 6.

In step A1, the abnormality detection unit 12 determines a path state of the storage system 4. In a case where the path state is normal (see “normal” route of step A1), the process ends.

On the other hand, in a case where the path state is determined to be abnormal (see a “ABNORMAL” route of step A1), the specifying unit 13 determines an abnormal place in step A2. As a result of this determination, in a case where the abnormal place is located between the host apparatus 2 and the switch 3 (see a route “BETWEEN HOST AND SW” in step A2), and in a case where the host apparatus 2 is compliant with the TPGS, in step A3, the switching control unit 14 causes the host apparatus 2 to perform the TPGS path closing, thereby performing switching to the standby path.

On the other hand, in a case where the abnormal place is located between the switch 3 and the storage apparatus 1 (see a route “BETWEEN SW AND STORAGE” of step A2), the switching control unit 14 causes the target path to be in the link down state, thereby performing switching to the standby path for the host apparatus 2. Thereafter, the process ends.

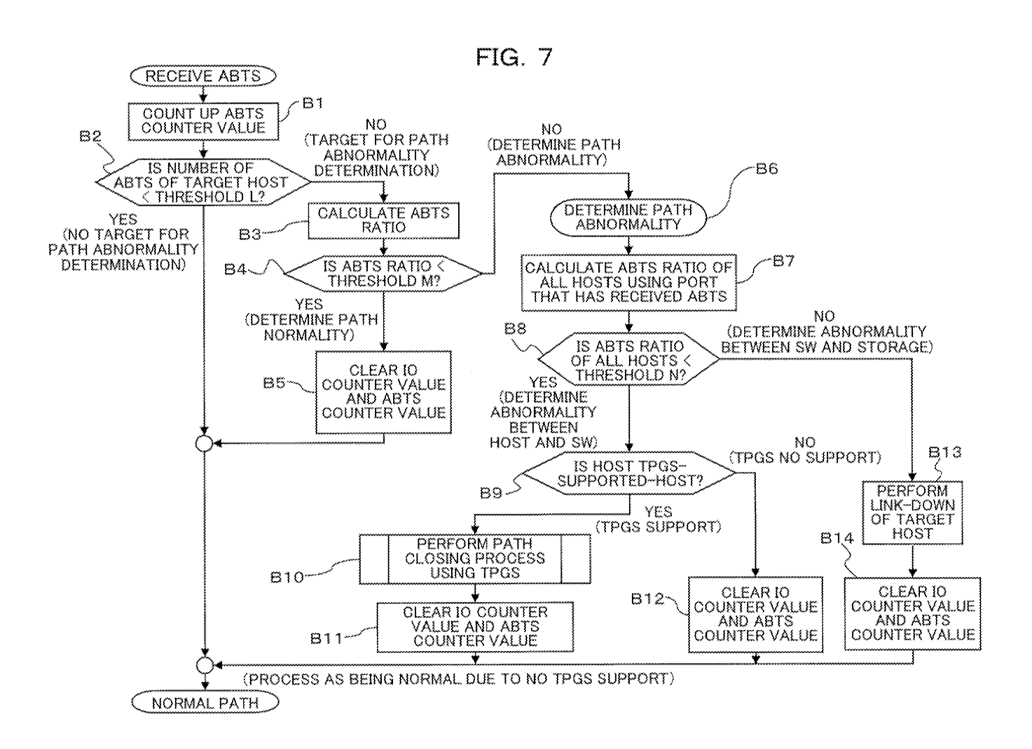

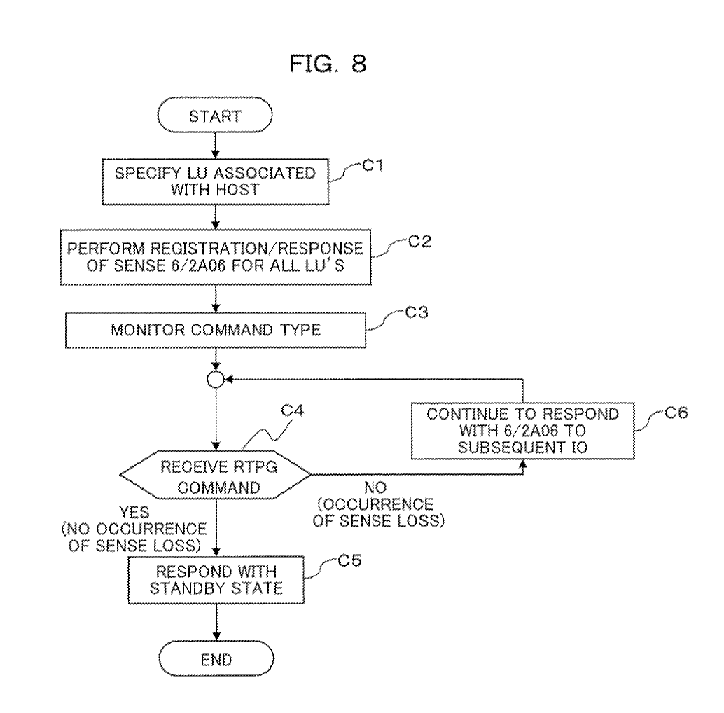

Next, the path switching process performed by the storage system 4 as an example of the embodiment will be described in detail with reference to a flowchart (steps B1 to B14) illustrated in FIG. 7

When the storage apparatus 1 receives an ABTS from the host apparatus 2, in step B1, the IO management unit 11 counts up the IO counter value 61 and the ABTS counter value 62 and records the resultant values in the management table 63.

In step B2, the abnormality detection unit 12 compares the number of ABTSs with the threshold L for the host apparatus 2 (target host) that is a transmission source of the ABTSs. In a case where the number of the ABTSs is less than the threshold L (see Yes route of step B2), the case is not a target for a path abnormality determination, the path is regarded to be normal, and the process ends.

On the other hand, in a case where the number of the ABTSs is the threshold L or more (see No route of step B2), the case is a target for a path abnormality determination, and, in step B3, the abnormality detection unit 12 calculates a ratio (ABTS ratio) of the number of the ABTSs to the number of IOs.

In step B4, the abnormality detection unit 12 compares the ABTS ratio calculated in step B3 with the threshold M. As a result of this comparison, in a case where the ABTS ratio is less than the threshold M (see Yes route of step B4), the path is determined to be normal, and, in step B5, the IO counter value 61 and the ABTS counter value 62 are cleared. Thereafter, the process ends.

In addition, in a case where the ABTS ratio is the threshold M or more (see No route of step B4), the abnormality detection unit 12 determines a path abnormality in step B6, and next, the abnormal place is specified by the specifying unit 13.

In step B7, the specifying unit 13 calculates the ABTS ratio the ABTS ratio of all the hosts) of all the host apparatuses 2 using the ports P0 to P3 arranged in the storage apparatus 1.

In step B8, the specifying unit 13 compares the ABTS ratio of all the hosts, which has been calculated in step B7, with the threshold N. As a result of the comparison, in a case where the ABTS ratio of all the hosts is the threshold N or more (see No route of step BB), the abnormal place is determined to be located between the switch 3 and the storage apparatus 1. Thus, in step B13, the switching control unit 14 sets a port (target port) to which the abnormal path is connected to be in the link down state in the storage apparatus I. Accordingly, the host apparatus 2 detects this link down and performs switching to the standby path.

Thereafter, in step B14, the IO counter value 61 and the ABTS counter value 62 are cleared, and the process ends.

On the other hand, in a case were the ABTS ratio of all the hosts is less than the threshold N (see Yes route of step B8), the abnormal place is determined to be located between the host apparatus 2 and the switch 3. Thus, in step 59, the switching control unit 14 checks whether or not the host apparatus 2 that is the transmission source of the ABTS is compliant with the TPGS by referring to the management table 63.

In a case where the host apparatus 2 is compliant with the TPGS (see Yes route of step B9), in step B10, the switching control unit 14 instructs the host apparatus 2 to close the TPGS path. The host apparatus 2 that has received the instruction for closing the TPGS path performs the TPGS path closing process, thereby performing switching the path from the abnormal path to the standby path. The TPGS path closing process performed by the host apparatus 2 will be described later in detail, with reference to FIG. 8.

Thereafter, in step B11, the IO counter value 61 and the ABTS counter value 62 are cleared, and the process ends.

On the other hand, in a case where the host apparatus 2 is not compliant with the TPGS (see No route of step B9), in step B12, the IO counter value 61 and the ABTS counter value 62 are cleared, and the process ends.

In other words, in a case where the host apparatus 2 is not compliant with the TPGS, link-down and the like are not performed, and the path is handled as being normal. By suppressing the link-down, there is no influence on accesses from the other host apparatuses 2. In addition, when reissuance (retry) of the IO command is performed by the host apparatus 2 that has issued the ABTS, in a case where the path abnormality is temporary, it can be expected that the path abnormality is resolved when the retrying is made.

Next, the TPGS path closing process performed by the storage system 4 as an example of the embodiment will be described with reference to a flowchart (steps C1 to C6) illustrated in FIG. 8. This TPGS path closing process is performed in a case where the host apparatus 2 is compliant with the TPGS and corresponds to the process of step B10 of the flowchart illustrated in FIG. 7.

In step C1, the switching control unit 14 specifies all the logical units (LUs) registered in an affinity group of the target host apparatus 2.

In step C2, the switching control unit 14 registers (maintains) a multi-path rebuilding sense (for example, a sense of 6/2 A06) for all the LUs registered in the affinity group of the target host apparatus 2 and responds thereto. When the sense of 62 A06 is received by the storage apparatus 1, an RTPG command is configured to be issued to the host apparatus 2 according to the specification.

In step C3, the switching control unit 14 monitors a command that transmitted from the host apparatus 2. More specifically, the switching control unit 14 checks whether or not an RTPG command for the sense of 6/2 A06 has been received from the host apparatus step C4.

In a case where the storage apparatus 1 has not received an RTPG command from the host apparatus 2 (see No route of step C4), an occurrence of a sense loss is determined, and, in step C6, the switching control unit 14 continuously performs a response of the sense of 6/2 A06 to a transition IO.

This process corresponds to step B10 of the flowchart illustrated in FIG. 7 and is performed under situation in which a path abnormality occurs and is based on the premise of a so-called unstable path such as a path in which a frame loss intermittently occurs. Thus, even when an RTPG command is transmitted from the host apparatus 2, there is concern that the RTPG command may not be immediately received by the storage apparatus 1. For this reason, in a case where an RTPG command is not received in step C4, in step C6, a response of the sense of 6/2 A06 is continuously performed from the storage apparatus 1.

On the other hand, in a case where the storage apparatus 1 receives an RTPG command from the host apparatus 2 (see Yes route of step C4), no occurrence of a sense loss is determined. In step C5, the switching control unit 14 makes a response of a standby state to the received RTPG command, thereby urging the host apparatus 2 to switch to the standby path.

Accordingly, the multi-path driver of the host apparatus 2 that has received the standby state closes the active path, thereby performing switching to the standby path. A technique for receiving the standby state and switching the path to the standby path in the host apparatus 2 is known, and description thereof will not be presented.

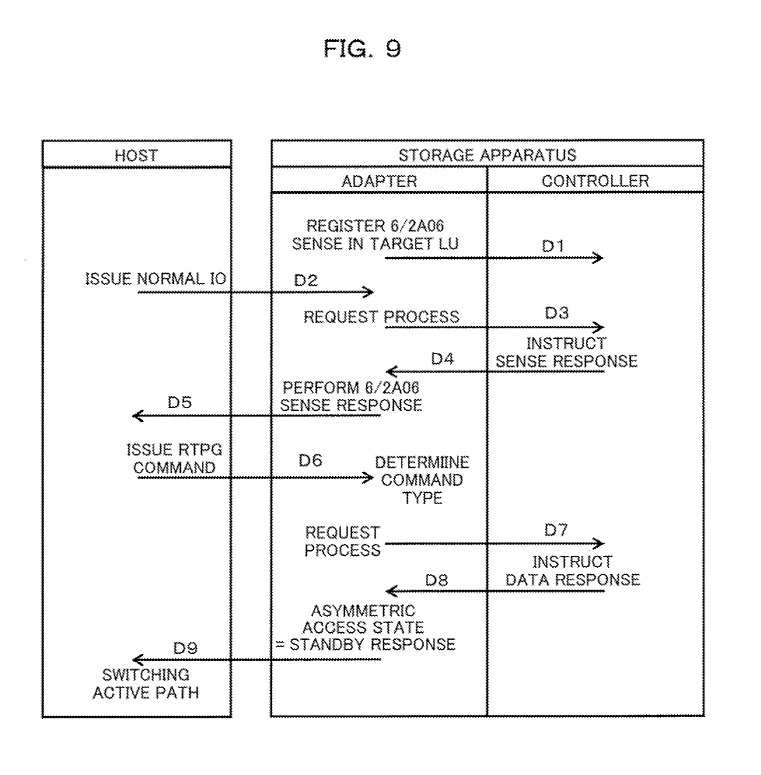

FIG. 9 is a sequence diagram that illustrates the TPGS path closing process performed by the storage system 4 as an example of the embodiment in a case where no sense loss occurs.

In FIG. 9, an adaptor of the storage apparatus 1 corresponds to the CN 101, and a controller corresponds to the CPU 116.

As illustrated in FIG. 9, for the controller of the storage apparatus 1, a 6/2 A06 sense is registered. in the target (see reference sign D1). Thereafter, when an IO (normal IO) is issued from the host apparatus 2 (see reference sign D2), a process of the corresponding IO is requested from the adaptor to the controller (see reference sign D3).

The controller instructs the adaptor to make a sense response (see reference sign D4), and the adaptor makes a 6/2 A06 sense response to the host apparatus 2 according to the instruction (see reference sign D5).

When the 6/2 A06 sense response arrives at the host apparatus 2, the host apparatus 2 issues an RTPG command (see reference sign D6), and the adaptor that has received this RTPG command determines the command type.

The adaptor requests the controller to perform the process of the determined command (RTPG command) (see reference sign D7), and the controller instructs the adaptor to make a data response (see reference sign D8). The adaptor makes a response of standby to the host apparatus 2 as a port group state (asymmetric access state) according to this instruction (see reference sign D9). This standby response serves as a path state change notification from m the storage apparatus 1 to the host apparatus 2.

For the host apparatus 2 that has received this response, the multi-path driver closes the active path and performs switching to the standby path.

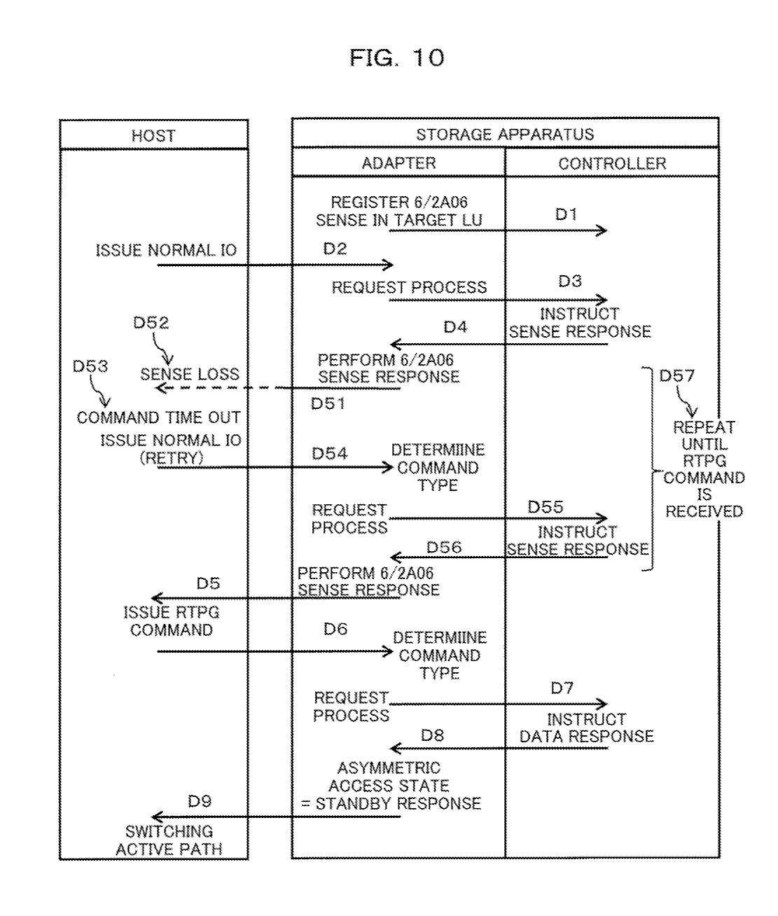

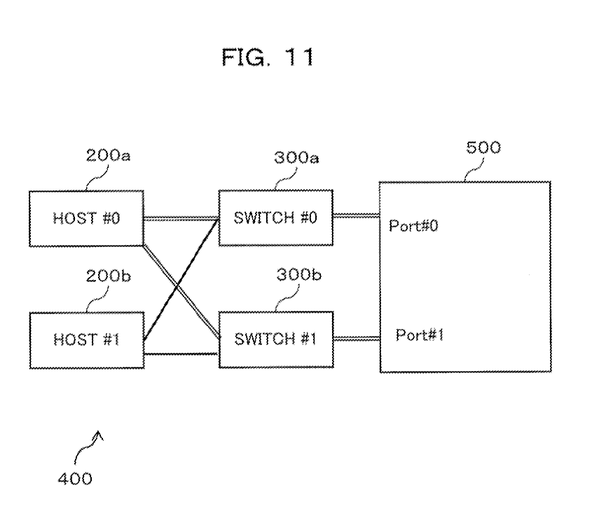

FIG. 10 is a sequence diagram that illustrates the TPGS path closing process performed by the storage system 4 as an example of the embodiment in a case where a sense loss occurs. The sequence represented in FIG. 10 illustrates a case where a loss of a sense response to the host apparatus 2 occurs according to the influence of a path abnormality.

In the sequence illustrated in FIG. 10, in addition to each process performed in the sequence illustrated in FIG. 9, the process represented by reference signs D51 to D57 is included, and the other portions are similar to the process illustrated in FIG. 9. In the figures, the same reference sign as the above-described reference sign represents the same process, and description thereof will not be presented.

The controller instructs the adaptor to make a sense response (see reference sign D4), and the adaptor makes the 6/2 A06 sense response to the host apparatus 2 according to this instruction (see reference sign D51).

However, since the path is unstable, this 6/2 A06 sense response does not arrive at the host apparatus 2, and a sense loss occurs (see reference sign D52). For the host apparatus 2, as a predetermined time elapses after the normal IO is issued, the command is time out (see reference sign D53).

The host apparatus 2 reissues an IO (normal IO) (see reference sign D54), and the process of the corresponding IO is requested from the adapter that has received the IO to the controller (see reference sign D55). The controller instructs the adaptor to make a sense response (see reference sign D56), and the adaptor makes the 6/2 A06 sense response to the host apparatus 2 according to this instruction (see reference sign D5).

The process represented by reference signs D51 to D56 described above is repeatedly performed until the storage apparatus 1 receives an RTPG command (see reference sign D57).

In this way, according to the storage apparatus 1 as an example of the embodiment, when a path abnormality is detected, the specifying unit 13 specifies an abnormal place, and the switching control unit 14 causes the host apparatus 2 to perform path switching according to the abnormal place.

In other words, in a case where the abnormal place is located between the host apparatus 2 and the switch 3, the host apparatus 2 is caused to perform the TPGS path closing process or the path is regarded to be normal, whereby a link-down is prevented. Accordingly, accesses from the other host apparatuses 2 using the same port as that used by the host apparatus 2 that is the transmission source of the ABTS to the target port are not blocked. In other words, there is no influence, on the accesses from the other host apparatuses 2 to the target port, and the system can be stably operated.

When IO retrying is performed by the host apparatus 2 that has issued the ABTS, in a case where a path abnormality is temporary, it can be expected that the path abnormality is resolved when the retrying is performed. Thus, the path abnormality can be resolved without causing a link down, and accordingly, an access from the host apparatus 2 to the storage apparatus 1 is not blocked.

In a case where the abnormal place is located between the switch 3 and the storage apparatus 1, the switching control unit 14 causes a link down of the target port. In this way, the host apparatus 2 that has detected this link down performs path switching to the standby path, and accordingly, the path switching to the standby path can he reliably performed so as to improve the reliability.

The path formed between the switch 3 and the storage apparatus 1 is used for an access to the port from each host apparatus 2, and, in a case where this path is the abnormal place, it is preferable to resolve the path abnormality as soon as possible. Thus, by causing the communication port engaged in the path to be in the port stopped state as soon as possible so as to be in the link down state, path switching is performed in a speedy manner, and the system can be quickly returned to the stable state, whereby the reliability is improved.

In a case where an abnormal place is located between the host apparatus 2 and the switch 3, and the host apparatus 2 is compliant with the TPGS, the switching control unit 14 causes the host apparatus 2 to perform the TPGS path closing process. Accordingly, the path switching to the standby path can be reliably performed, whereby the reliability is improved.

In a case where an abnormal place is located between the host apparatus 2 and the switch 3, but the host apparatus 2 is not compliant with the TPGS, a link down or the like is not caused, and the path is handled as being normal, whereby the link down is suppressed. Accordingly, accesses from the other host apparatuses 2 are not influenced.

By detecting an unstable path such as a path in which a frame loss intermittently occurs and switching the path to a normal path, the system can be operated in a stable manner.

The present invention is not limited to the embodiment described above, but various changes may be made therein in a range not departing from the concept of the embodiment.

For example, in the embodiment described above, while the storage system 4 includes two host apparatuses 2 and two switches 3, the storage system is not limited thereto. In other words, the storage system may include three or more host apparatuses 2 and three or more switches 3. In addition, the configuration of the storage apparatus 1 may be appropriately changed.

In addition, in the embodiment described above, while an example has been illustrated in which the host apparatus 2 performs path switching from the active path to the standby path according to the detection of a link down or an instruction transmitted from the switching control unit 14, the present invention is not limited thereto. In other words, by including a switch (relay apparatus) 3 that is compliant with the TPGS and issuing a path switching instruction from the switching control unit 14 to the switch 3, the path switching from the active path to the standby path may be performed. In addition, by detecting an occurrence of a link down, the switch 3 may perform path switching from the active path to the standby path.

In addition, in the embodiment described above, while the switch 3 is included as the relay apparatus connecting the host apparatus 2 and the storage apparatus 1, the relay apparatus is not limited thereto, but any other relay apparatus such as a bridge or a router may be used.

Furthermore, according to the disclosure described above, this embodiment may be performed or manufactured by a person skilled in the art.

According to an embodiment, effective path switching according to a place at which a path abnormality occurs can be performed.

All examples and conditional language recited herein are intended for the pedagogical purposes of aiding the reader in understanding the invention and the concepts contributed by the inventor to further the art, and are not to be construed limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. A storage system in which a plurality of higher-level apparatuses are connected to a storage apparatus through a relay apparatus in a plurality of paths, the storage system comprising;
the storage apparatus including a memory device;
the plurality of higher-level apparatuses;
the relay apparatus;
an abnormality detection unit that detects an occurrence of an abnormality in any one of the plurality of paths;
a specifying unit that specifies an abnormal place on a basis of the number of communication abnormalities and the number of IOs when the occurrence of the abnormality is detected in the path; and
a switching control unit that performs control for causing any one of the plurality of higher-level apparatuses and the relay apparatus to execute switching of a data communication path from the path in which the occurrence of the abnormality is detected to another path among the plurality of paths in accordance with the specified abnormal place.

2. The storage system according to claim 1, wherein the switching control unit executes the path switching by causing a communication port to be in a communication disable state by executing a port stopping process causing the communication port of the storage apparatus to which the relay apparatus is connected to be in the communication disable state in a case where the abnormal place is between the relay apparatus and the storage apparatus.

3. The storage system according to claim 2, wherein the switching control unit suppresses the execution of the port stopping process in a case where the abnormal place is other than a place disposed between the relay apparatus and the storage apparatus.

4. The storage system according to claim 3, wherein the switching control unit executes the path switching by transmitting a path switching instruction to the higher-level apparatus in a case where the abnormal place is other than a place disposed between the relay apparatus and the storage apparatus, and the higher-level apparatus has a path switching control function.

5. The storage system according to claim 1, wherein the abnormality detection unit detects an occurrence of an abnormality in the path on a basis of a ratio of the number of communication abnormalities to the number of IOs for the higher-level apparatus of an issuance source of a communication abnormality notification signal.

6. The storage system according to claim 1, wherein the specifying unit specifies an abnormal place on a basis of a ratio of the number of communication abnormalities to the number of IOs for all the higher-level apparatuses using a communication port of the storage apparatus.

7. A control apparatus for controlling a storage apparatus that is connected to a plurality of higher-level apparatuses in a plurality of paths through a relay apparatus, the control apparatus comprising:
an abnormality detection unit that detect an occurrence of an abnormality in any one of the plurality of paths;
a specifying unit that specify an abnormal place on a basis of the number of communication abnormalities and the number of IOs when the occurrence of the abnormality is detected in the path; and
a switching control unit that perform control for causing any one of the plurality of higher-level apparatuses and the relay apparatus to execute path switching of a data communication path from the path in which the occurrence of the abnormality is detected to any other standby path among the plurality of paths In accordance with the specified abnormal place.

8. The control apparatus according to claim 7, wherein the switching control unit executes the switching to any other standby path by causing a communication port to be in a communication disable state by executing a port stopping process causing the communication port of the storage apparatus to which the relay apparatus is connected to be in the communication disable state in a case where the abnormal place is between the relay apparatus and the storage apparatus.

9. The control apparatus according to claim 8, wherein the switching control unit suppresses the execution of the port stopping process in a case where the abnormal place is other than a place disposed between the relay apparatus and the storage apparatus.

10. The control apparatus according to claim 9, wherein the switching control unit executes the path switching by transmitting a path switching instruction to the higher-level apparatus in a case where the abnormal place is other than a place disposed between the relay apparatus and the storage apparatus, and the higher-level apparatus has a path switching control function.

11. The control apparatus according to claim 7, wherein the abnormality detection unit detects an occurrence of an abnormality in the path on a basis of a ratio of the number of communication abnormalities to the number of IOs for the higher-level apparatus of an issuance source of a communication abnormality notification signal.

12. The control apparatus according to claim 7, wherein the specifying unit specifies an abnormal place on a basis of a ratio of the number of communication abnormalities to the number of IOs for all the higher-level apparatuses using a communication port of the storage apparatus.

13. A non-transitory computer-readable recording medium having stored therein a control program for causing a computer to execute a process in a storage apparatus connected to a plurality of higher-level apparatuses in a plurality of paths through a relay apparatus, the process comprising:
detecting an occurrence of an abnormality in any one of the plurality of paths;
specifying an abnormal place on a basis of the number of communication abnormalities and the number of IOs when the occurrence of the abnormality is detected in the path; and
performing control for causing any one of the plurality of higher-level apparatuses and the relay apparatus to execute path switching of a data communication path from the path in which the occurrence of the abnormality is detected to another path among the plurality of paths in accordance with the specified abnormal place.

14. The non-transitory computer-readable recording medium according to claim 13, wherein the path switching is executed by causing a communication port to be in a communication disable state by executing a port stopping process causing the communication port of the storage apparatus to which the relay apparatus is connected to be in the communication disable state in a case where the abnormal place is between the relay apparatus and the storage apparatus.

15. The non-transitory computer-readable recording medium according to claim 14, wherein the process further comprises suppressing the execution of the port stopping process in a case were the abnormal place is other than a place disposed between the relay apparatus and the storage apparatus.

16. The non-transitory computer-readable recording medium according to claim 15, wherein the path switching is executed by transmitting a path switching instruction to the higher-level apparatus in a case where the abnormal place is other than a place disposed between the relay apparatus and the storage apparatus, and the higher-level apparatus has a path switching control function.

17. The non-transitory computer-readable recording medium according to claim 13, wherein the occurrence of an abnormality is detected in the path on a basis of a ratio of the number of communication abnormalities to the number of IOs for the higher-level apparatus of an issuance source of a communication abnormality notification signal.

18. The non-transitory computer-readable recording medium according to claim 13, wherein the abnormal place is specified based on a ratio of the number of communication abnormalities to the number of IOs for all the higher-level apparatuses using a communication port of the storage apparatus.
